(19) United States
(12) Patent Application Publication
(10) Pub. No.: US 2014/0214833 A1
(43) Pub. Date: Jul. 31, 2014

(54) SEARCHING THREADS

(71) Applicant: HEWLETT-PACKARD DEVELOPMENT COMPANY, L.P., Houston, TX (US)

(72) Inventor: Mehmet Kivanc Ozonat, San Jose, CA (US)

(73) Assignee: Hewlett-Packard Development Company, L.P., Houston, TX (US)

(21) Appl. No.: 13/755,771

(22) Filed: Jan. 31, 2013

(51) Int. Cl. G06F 17/30

(52) U.S. Cl. CPC G06F 17/30598
USPC 707/737

(57) ABSTRACT

Searching threads can comprise extracting a number of keywords from a number of threads inside a discussion forum in response to a search query, clustering the number of keywords utilizing thread titles and thread content from the within the number of threads, and searching for a thread from within the number of threads that is relevant to the search query based on the clustering.

### BACKGROUND

Online discussion forums (e.g., online product discussion forums) consist of threads, where each thread may include posts by multiple customers discussing a problem (e.g., a product problem). The threads can provide useful information to customers who want to find an answer, (e.g., a fix for a product problem) while reducing a workload of support desks (e.g., of a manufacturer).

Prior approaches to searching threads include utilizing web search models; however, due to a lack of links between threads, searches and results can be inaccurate, leaving customers without a relevant answer.

### BRIEF DESCRIPTION OF THE DRAWINGS

FIG. 1 is a block diagram illustrating an example of a method for searching threads according to the present disclosure.

FIG. 2A is an example of a data tree structure according to the present disclosure.

FIG. 2B is an example of a set of data tree structures according to the present disclosure.

FIG. 3 illustrates an example system according to the present disclosure.

### DETAILED DESCRIPTION

Customers of enterprises (e.g., large organizations) can post threads in enterprise-supported online forums to discuss solutions to product malfunctions, errors, and problems. The ability to retrieve the most relevant threads in response to a customer's search query (e.g., question about a problem, malfunction, etc.) in the product forums requires robust search capabilities. However, the lack of (recommendation) links between the threads in the product discussion forums makes it infeasible to use web search algorithms such as PageRank in these forums.

The product forum threads rarely contain links between each other or links from other web sites; thus, it is not feasible to utilize web search models such as PageRank in the product forum settings. Consequently, most forums rely solely on word matching algorithms for search (e.g., the forum search engine retrieves and ranks the threads based on the number of words common to the search query and each thread). This can lead to poor search and retrieval results. In contrast, a statistical clustering-based approach to the search and retrieval problem of product threads according to the present disclosure can search for and retrieve threads relevant to a search query.

For example, searching threads according to the present disclosure can include providing a keyword extraction technique based on term co-occurrences that perform better than traditional term frequency-inverse document frequency—(tfidf) based techniques. Searching threads according to the present disclosure can include providing a search and retrieval model to retrieve the relevant threads in response to a search query in product discussion forums. This can be based, for example, on a hierarchical, multi-view (e.g., thread title and thread content) clustering of the threads.

In a number of examples, systems, methods, and computer-readable and executable instructions are provided for searching threads. An example method for searching threads can include extracting a number of keywords from a number of threads inside a discussion forum in response to a search query, clustering the number of keywords utilizing thread titles and thread content from the within the number of threads, and searching for a thread from within the number of threads that is relevant to the search query based on the clustering.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “N”, “P,” “R”, and “S” particularly with respect to reference numerals in the drawings, indicate that a number of the particular feature so designated can be included with a number of examples of the present disclosure. Also, as used herein, “a number of” an element and/or feature can refer to one or more of such elements and/or features.

Searching threads according the present disclosure can include providing a statistical clustering-based approach to search and retrieval issues of product threads (e.g., missing links). The approach can include utilizing term co-occurrence keyword extraction, multi-view perspective, and hierarchical clustering, for example.

Keyword extraction can be utilized to increase accuracy of search and retrieval of forum threads. Prior approaches to keyword extraction include techniques based on the tfidf method. In the tfidf method, the word frequencies in a repository are compared with the word frequencies in the sample text; if the frequency of a word in the sample text is high while its frequency in the repository is low, the word is extracted as a keyword. In the context of mining customer forums, this approach has shortcomings. For example, a customer forum thread typically contains only a few sentences and words, making it difficult to obtain reliable statistics based on word frequencies. Many relevant words appear only once in the thread, making it difficult to distinguish them from the other, less relevant words of the thread. In contrast, searching threads according to the present disclosure addresses this issue with term co-occurrence keyword extraction, a technique that discovers significant terms in the entire forum and uses the significant terms only to later cluster the similar threads.

In a number of embodiments, during the clustering, both the thread title and the thread content can be utilized as features. A thread title (often consisting of just a few words) has a very different characteristic than the thread content (often consisting of at least several sentences), making it challenging to combine the two into one feature vector. To address this, the threads can be clustered using two views of the data: the title view and the content view.

The threads can be clustered in a hierarchical fashion. This way, the customer can be presented (e.g., first presented) with the threads of the most relevant cluster; if he or she desires to view more threads, more threads can be included to the presentation by including the threads of the clusters higher in the hierarchy. Prior approaches to clustering have focused on multi-view models within a semi-supervised setting or multi-view clustering with no supervision, including building a single dendrogram by merging the closest clusters based on two distances, one for each of the two views.

However, while searching threads according to the present disclosure can include unsupervised clustering (e.g., find hidden structure in unlabeled data.), the single dendogram approach is not applicable to consumer product support forums. For example, while thread titles (short, often just a few words) are representative of customer queries, thread content (consisting of multiple sentences) is not representative of the queries.

Searching for threads relevant to a search query can include building a repository of keywords relevant to the search query. These keywords can be clustered according to whether they are relevant to the title and/or the content of the thread, and these results can be taken together (e.g., minimizing a probability of disagreement between the clusters) to determine which threads in the forum are relevant to the search query.

For example, an i^{th} thread within the number of threads, 1≦i≦N, can be represented by a pair of feature vectors: x_{i,1} the feature vector for the thread title, and x_{i,2}, the feature vector for the thread content, where N is the cardinality of the number of threads. The set for the thread titles can be denoted as X₁={x_{1,1}, x_{2,1}, . . . , x_{N,1}}, and the set for the thread content can be denoted as X₂={x_{1,2}, x_{2,2}, . . . , x_{N,2}}.

In a number of examples, each feature vector is a W-length binary (e.g., 0 or 1) vector, where W is the total number of unique words used across all threads. Each word is indexed by w, where 1≦w≦W. In some examples, the w^{th} element of x_{i,1} is 1 if and only if the word w occurs in the title of the i^{th} thread. In some examples, as will be discussed further herein, stop-words (e.g., and, if, such, etc.) can be excluded from the feature vectors.

Two clustering decisions can be focused on: one is a function of the set X₁ and the other is a function of the set X₂. Each of the two functions can be designed with guidance from the other with the goal of reducing (e.g., minimizing) the disagreement between the two. Denoting the clustering functions of X₁ and X₂ by α₁(X₁) and α₂(X₂), respectively, the goal is to find the pair of functions α₁ and α₂ that minimizes:

P(α₁(X₁)≠α₂(X₂)), (1)

where P is an empirical probability.

In order to reduce the effects of overfitting, (e.g., describing random error or noise instead of the underlying relationship) the minimization in (1) can be performed under a constraint on the entropy of clusters. The problem of minimizing (1) with constraints on the entropy of clusters can be viewed as a Lagrangian problem with the cost function:

P(α₁(X₁)≠α₂(X₂))+λᵥRᵥ, v=1, 2 (2)

where R₁ is a constraint on the entropy of clusters of α₁, R₂ is a constraint on the entropy of clusters of α₂, and λ₁ and λ₂ are the Lagrangian parameters. In a number of examples, the number of clusters to search and review (e.g., to find a relevant thread) can be reduced (e.g., minimized) by minimizing equation (2). This can result, for example, in a faster response to the search query, since a reduced number of threads and keywords are searched.

Information-theoretic entropy can be used as an overfitting penalty term in designing statistical clustering algorithms. For example, if Rᵥ, v=1, 2, is the entropy of the clusters, then:

$${R}_{v} = - {\sum }_{i = 1}^{{K}_{v}} P ( {α}_{v} ( {X}_{i} ) ) log P ( {α}_{v} ( {X}_{i} ) ) , \\ v = 1 , 2 , \qquad ( 3 )$$

where the probabilities are empirical, and Kᵥ is the number of clusters for αᵥ.

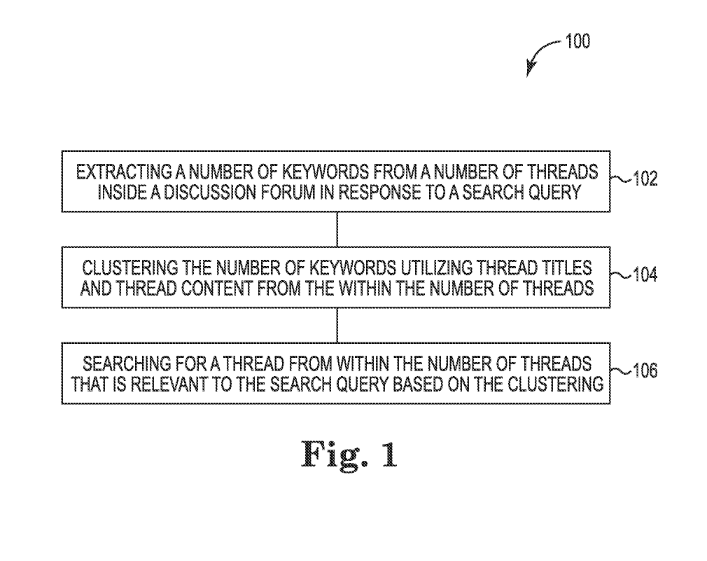

FIG. 1 is a block diagram illustrating an example of a method 100 for searching threads according to the present disclosure. In a number of examples, searching threads can include searching consumer product support forums. These forums can have the characteristic that a customer is interested in only those threads that address his or her problem. This is in contrast to other forums, wherein the customer may instead have a desire and/or interest to jump between related topics. Each thread in the consumer product support forum can be viewed as a title-content pair, such that the thread title may comprise only a limited number of words (e.g., 2, 3, 4, etc), and the content can include a relatively larger number of words (e.g., a paragraph or more).

At 102, a number of keywords is extracted from a number of threads inside a discussion forum in response to a search query. For example, a consumer may enter a search query related to a problem with a particular product. In response, keywords can be extracted from threads within the forum that are relevant to the query. A relevance can include, for example, a relationship to a target (e.g., similar product problem).

Keyword extraction can include a tagging and themetization method that can support search and retrieval capabilities for a discussion forum (e.g., consumer product support forum). Keyword and key phrase extraction can include extracting words and phrases (e.g., two or more words) based on term co-occurrences that can result in increased search and retrieval accuracy, as well as extraction accuracy, over other techniques, for example.

In a number of embodiments, keyword extraction can include extracting (e.g., automatically extracting) structured information from unstructured and/or semi-structured computer-readable documents. Keyword extraction techniques can be based on the tfidf method. However, in a number of embodiments, tfidf may have shortcomings. For example, a customer forum thread may contain only a few sentences and words, making it difficult to obtain reliable statistics based on word frequencies. Many relevant words may appear only once in the thread, making it difficult to distinguish them from the other, less relevant words of the thread, for example.

Utilizing a vector of keywords can result in increasingly accurate keyword extraction. For example, a vector of keywords can be formed in a repository of forum threads, and a binary features vector for each thread can be generated. For example, a thread title feature vector and a thread content feature vector can be generated for each thread.

If the ith repository keyword appears in the thread, the ith element of the thread's feature vector is 1, and if the keyword does not appear in the thread, the ith element of the thread's feature vector is 0, for example. A number of different approaches can be used to generate keywords in a given repository.

In some examples, when generating keywords, stop words (e.g., if, and, we, etc.) can be filtered from a repository, and a vector of keywords can be the set of all remaining distinct repository words. In a number of embodiments, only stop words are filtered from the repository.

In some embodiments of the present disclosure, the tfidf method can be applied to the entire repository by comparing the word frequencies in the repository with word frequencies in the English language when generating keywords. For example, if the frequency of a word is higher in the repository (e.g., meets and/or exceeds some threshold) in comparison to the English language (e.g., and/or other applicable language), the word can be taken the word as a keyword.

In some examples, generating keywords can include utilizing term co-occurrence. A term co-occurrence method can include extracting keywords from a repository without comparing the repository frequencies with language frequencies. For example, let N denote a number of all distinct words in the repository of forum threads. An N×M co-occurrence matrix can be constructed, where M is a pre-selected integer with M<N. In an example, M can be 500. Distinct words (e.g., all distinct words) can be indexed by n, (e.g., 1≦n≦N). The most frequently observed M words can be indexed in the repository by m such that 1≦m≦M. The (n:m) element (e.g., nth row and the mth column) of the N×M co-occurrence matrix counts the number of times the word n and the word m occur together.

In an example, the word “wireless” can have an index n, the word “connection” can have an index m, and “wireless” and “connection” can occur together 218 times in the repository; therefore, the (n:m) element of the co-occurrence matrix is 218. If the word n appears independently from the words 1≦m≦M (e.g., the frequent words), the number of times the word n co-occurs with the frequent words is similar to the unconditional distribution of occurrence of the frequent words. On the other hand, if the word n has a semantic relation to a particular set of frequent words, then the co-occurrence of the word n with the frequent words is greater than the unconditional distribution of occurrence the frequent words. The unconditional probability of a frequent word m can be denoted as the expected probability pₘ, and the total number of co-occurrences of the word n and frequent terms can be denoted as cₙ. Frequency of co-occurrence of the word n and the word m can be denoted as freq(n;m). The statistical value of x² can be defined as:

$${x}^{2} ( n ) = {\sum }_{1 \leq m \leq M} \frac{freq ( n , m ) - {N}_{n} {p}_{m}}{{n}_{m} {p}_{m}} . \qquad ( 4 )$$

At 104, the number of keywords are clustered utilizing thread titles and thread content from the within the number of threads. A hierarchical, multi-view clustering approach can be used, wherein the multi-views include a thread title view and a thread content view. By utilizing thread titles and thread content, the accuracy and relevancy of thread searches and retrieval can be increased.

In a number of embodiments, keywords can be clustered, for example, if the frequent words m₁ and m₂ co-occur frequently with each other and/or the frequent words m₁ and m₂ have a same and/or similar distribution of co-occurrence with other words. To quantify the first condition of m₁ and m₂ co-occurring frequently, the mutual information between the occurrence probability of m₁ and m₂ can be used. To quantify the second condition of m₁ and m₂ having a similar distribution of co-occurrence with other words, the Kullback-Leibler divergence between the occurrence probability of m₁ and m₂ can be used.

A Gauss mixture vector quantization (GMVQ) can be used to design a hierarchical clustering model. For example, consider the training set {z₁, 1≦i≦N} with its (not necessarily Gaussian) underlying distribution f in the form f(Z)=Σₖpₖfₖ (Z). The goal of GMVQ may be to find the Gaussian mixture distribution, g, that minimizes the distance between f and g. A Gaussian mixture distribution g that can minimize this distance (e.g., minimizes in the Lloyd-optimal sense) can be obtained iteratively with the particular updates at each iteration.

Given μₖ, Σₖ, and pₖ for each cluster k, each zᵢ can be assigned to the cluster k that minimizes

$$\frac{1}{2} log ( \vert {\sum }_{k} \vert + \frac{1}{2} {( {z}_{i} - {μ}_{k} )}^{T} {\sum }_{k}^{- 1} ( {z}_{i} - {μ}_{k} ) - log {p}_{k} , \qquad ( 5 )$$

where |Σₖ| is the determinant of Σₖ.

Given the cluster assignments, μₖ, Σₖ, and pₖ can be set as:

$$\begin{matrix}{μ}_{k} = \frac{1}{‖ {S}_{k} ‖} {\sum }_{{z}_{i} ∈ {S}_{k}} {z}_{i} , & ( 6 ) \\ {\sum }_{k} = \frac{1}{‖ {S}_{k} ‖} {\sum }_{i} ( {z}_{i} - {μ}_{k} ) {( {z}_{i} - {μ}_{k} )}^{T} , \\ and & ( 7 ) \\ {p}_{k} = \frac{‖ {S}_{k} ‖}{N} , & ( 8 )\end{matrix}$$

where Sₖ is the set of training vectors zᵢ assigned to cluster k, and ∥Sₖ∥ is the cardinality of the set.

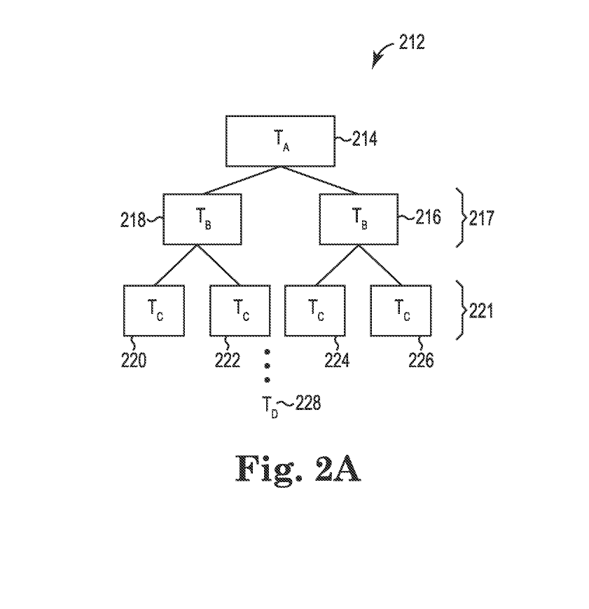

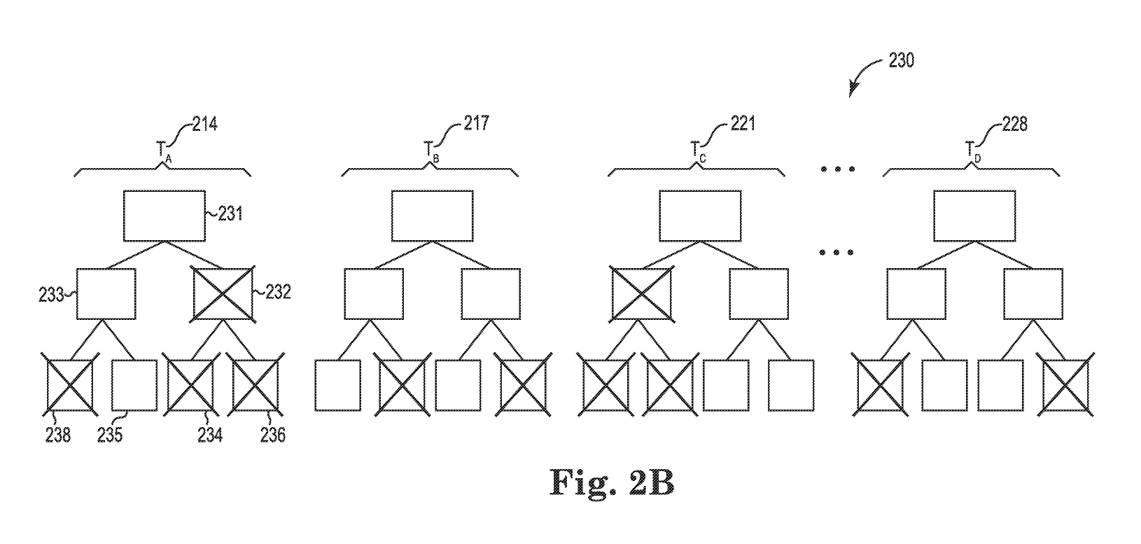

As will be discussed further herein with respect to FIGS. 2A and 2B, a Breiman, Friedman, Olshen, and Stone (BFOS) model can be used to design a hierarchical (e.g., tree-structured) extension of GMVQ. The BFOS model may require each node of a tree to have two linear functionals such that one of them is monotonically increasing and the other is monotonically decreasing. Toward this end, a QDA distortion of any subtree, T, of a tree can be viewed as a sum of two functionals, μ₁ and μ₂, such that:

$$\begin{matrix}{μ}_{1} ( T ) = \frac{1}{2} {\sum }_{k ∈ T} {l}_{k} log ( \vert {\sum }_{k} \vert + \frac{1}{N} {\sum }_{k ∈ T} {\sum }_{{z}_{i} ∈ {S}_{k}} \frac{1}{2} {( {z}_{i} - {μ}_{k} )}^{T} {\sum }_{k}^{- 1} ( {z}_{i} - {μ}_{k} ) , \\ and & ( 9 ) \\ {μ}_{2} ( T ) = - {\sum }_{k ∈ T} {p}_{k} log {p}_{k} , & ( 10 )\end{matrix}$$

where kεT denotes the set of clusters (e.g., tree leaves) of the subtree T.

A magnitude of μ₂/μ₁ can increase at each iteration. Pruning can be terminated when the magnitude μ₂/μ₁ of reaches A, resulting in the subtree minimizing μ₁+λμ₂.

At 106, method 100 can include searching for a thread from within the number of threads that is relevant to the search query based on the clustering. In a number of examples, the searched-for thread can be retrieved and presented to the user who submitted the query. By basing the search and retrieval on the clustering (e.g., multi-view, hierarchical clustering), the results are more accurate as compared to other search models (e.g., word matching models).

In a number of examples, by basing searching and retrieval on clusters (e.g., multi-view hierarchical clusters), a consumer with a search query can receive results (e.g., retrieved threads) in a rank-ordered fashion. In other words, hierarchical clustering can allow for the consumer to be first presented with the threads of the most relevant cluster, and if he or she desired to view more threads, more threads can be included in the presentation by including threads of the clusters higher in the hierarchy (e.g., higher in a tree-structure).

As previously discussed herein, a multi-view (e.g., thread title and thread content) hierarchical (e.g., tree-structured) clustering model can be utilized to increase (e.g., maximize) the accuracy of searching and retrieving threads relevant to a query. For example, two clustering trees can be iteratively designed, one using the thread title feature vectors, X_{i,1}, and the other using the thread content feature vectors, X_{i,2}. At each iteration, the two trees are designed (e.g., including tree growing and tree pruning) jointly to reduce (e.g., minimize) the disagreement probability with constraints on the entropy of clusters (e.g., equation (2)).

FIG. 2A is an example of a data tree structure 212 according to the present disclosure. Growing data trees can be utilized in a multi-view model to increase an accuracy of searches and retrievals associated with a search query. A data tree can include a number of nodes connected to form a number of node paths, wherein one of the nodes is designated as a root node. A root node can include, for example, a topmost node in the tree. Each individual node within the number of nodes can represent a data point. A terminal node can include a node of a data tree structure with no child nodes (e.g., a node below it in the tree). The number of node paths can show a relationship between the number of nodes. For example, two nodes that are directly connected (e.g., connected with no nodes between the two nodes) can have a closer relationship compared to two nodes that are not directly connected (e.g., connected with a number of nodes connected between the two nodes).

At each iteration, data tree 212 can start with a single node tree 214, called T_{A}, out of which two child nodes 216 and 218 are grown. The Lloyd model, as illustrated in equations (5)-(8) (e.g., grouping data points into a given number of categories) can be applied between these two child nodes 216 and 218, minimizing equation (5), and this new tree 217 can be denoted as T_{B}. In other words, each training vector is assigned to one of the two nodes 216 and 218.

One or both of the terminal nodes of T_{B} can be split. If just one node is selected, it is the one, among all the existing nodes, that reduces (e.g., minimizes) function (2) after the split. If both are split, two pairs of child nodes can be obtained (e.g., pair 220 and 222 and pair 224 and 226), and the Lloyd model (e.g., equations (5)-(8)) can be applied between each pair, minimizing equation (10) to obtain T_{C} 221. This procedure of splitting a tree, Tᵢ, and running the Lloyd model between pairs of the child nodes can be repeated until i=D, (e.g., tree T_{D} at 228) where D meets and/or exceeds a target threshold (e.g., D is sufficiently large). For example, the procedure can be repeated until a fully-grown tree is formed, as illustrated in FIG. 2B.

In a number of embodiments, growing trees can include growing a tree structured (TS) GMVQ tree T₁ (e.g., title feature tree) for the training set X_{i,1}, using u₁ and u₂ as given in equations (9) and (10), respectively and growing a TS-GMVQ tree T₂ (e.g., content feature tree) for the training set X_{i,2}, using u₁ and u₂ as given in equations (9) and (10), respectively.

FIG. 2B is an example of a set 230 of data tree structures (e.g., fully-grown trees) according to the present disclosure. Set 230 can consist of D trees, Tᵢ, (e.g., trees 214, 217, 221 . . . 228) where 1≦i≦D. As illustrated in FIG. 2B, each of the D trees, Tᵢ, where 1≦i≦D, can be pruned utilizing the BFOS model. Pruning (e.g., removing an irrelevant section of the tree) can depend on, for example, a change in the cost function, (e.g., equation (2)) as will be discussed further herein.

In the example illustrated in FIG. 2B, nodes that are covered with an “X” are pruned nodes, while other non-covered nodes are non-pruned nodes. For example, nodes 232, 234, 236, and 238 of tree 214 are pruned, while nodes 231, 233, and 235 are non-pruned nodes. In a number of examples, there are only two trees grown into fully-grown trees: a title feature tree T₁ and a content feature tree T₂.

The trees, T₁ and T₂, can be designed using the BFOS algorithm to minimize equation (2). This can imply that, at iteration m, the subtree functionals for T₁ are:

$$\begin{matrix}{u}_{1}^{m} ( T ) = {\sum }_{k ∈ {T}_{1}^{m}} {\sum }_{{x}_{i} ∈ {S}_{k}} P ( {α}_{1}^{m} ( {x}_{i , 1} ) \neq {α}_{2}^{m - 1} ( {x}_{i , 2} ) ) , \\ and & ( 11 ) \\ {u}_{2}^{m} ( T ) = - {\sum }_{k ∈ {T}_{1}^{m}} {p}_{k} log {p}_{k} . & ( 12 )\end{matrix}$$

The u₁ and u₂ functionals for T₂ are analogous, and by comparing equations (3) and (12), it can be observed that:

$${\sum }_{{T}_{i}} {u}_{2}^{m} ( T ) = {R}_{v} \qquad ( 13 )$$

and, by comparing equations (1) and (11), that:

$${\sum }_{{T}_{i}} {u}_{1}^{m} ( T ) = P ( {α}_{1}^{m} ( {X}_{1} ) \neq {α}_{2}^{m - 1} ( {X}_{2} ) ) . \qquad ( 14 )$$

The u₂^{m} in equation (12) is identical to the u₂ functional discussed previously with respect to GMVQ (e.g., equation (2)). As for the u₁^{m} functional, equation (9) can be used for growing the tree and equation (11) during the pruning. This is possible since (11) is also a linear and monotonically decreasing functional.

In a number of embodiments, pruning trees can include, for example, pruning the fully-grown T₁, given (e.g., with respect to) the tree T₂, using the BFOS model with u₁ and u₂ as given in equations (11) and (9), respectively. Similarly, given the tree T₁, the fully-grown T₂ can be pruned. Pruning can be stopped if a change in the cost function (e.g., equation (2)) from one iteration to the next is less than some E (e.g., which can be set such that the multi-view model stops if the change in the cost function is less than one percent from one iteration to the next). If the change in the cost function is more than E, the model can be started over, starting with growing a TS-GMVQ T₁ tree for the training set X_{i,1}, for example. In other words, if the change in the cost function is below a threshold value, pruning can be stopped, but if the change in the cost function is above the threshold value, the model (e.g., growing, pruning process) can be restarted (e.g., it's an iterative model).

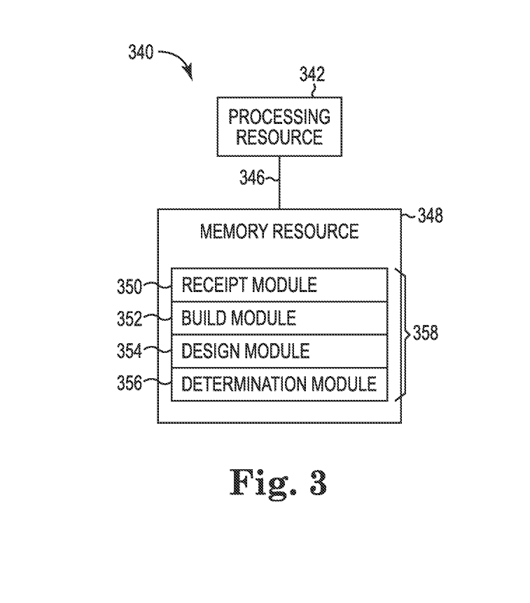

FIG. 3 illustrates a block diagram of an example of a system 340 according to the present disclosure. The system 340 can utilize software, hardware, firmware, and/or logic to perform a number of functions (e.g., searching threads).

The system 340 can be any combination of hardware and program instructions configured to search threads. The hardware, for example can include a processing resource 342, a memory resource 348, and/or computer-readable medium (CRM) (e.g., machine readable medium (MRM), database, etc.) A processing resource 342, as used herein, can include any number of processors capable of executing instructions stored by a memory resource 348. Processing resource 342 may be integrated in a single device or distributed across devices. The program instructions (e.g., computer-readable instructions (CRI)) can include instructions stored on the memory resource 348 and executable by the processing resource 342 to implement a desired function (e.g., searching threads).

The memory resource 348 (e.g., non-transitory CRM) can be in communication with a processing resource 342 and can include any number of memory components capable of storing instructions that can be executed by processing resource 342. Memory resource 348 (e.g., volatile and/or non-volatile memory) may be integrated in a single device or distributed across devices and may be fully or partially integrated in the same device as processing resource 342 or it may be separate but accessible to that device and processing resource 342.

The memory resource 348 can be integral, or communicatively coupled, to a computing device, in a wired and/or a wireless manner, and can be in communication with the processing resource 342 via a communication link (e.g., path) 346. The communication link 346 can be such that the memory resource 348 is remote from the processing resource (e.g., 342), such as in a network connection between the memory resource 348 and the processing resource (e.g., 342).

The processing resource 342 can be in communication with a memory resource 348 storing a set of CRI 358 executable by the processing resource 342, as described herein. The CRI 358 can also be stored in remote memory managed by a server and represent an installation package that can be downloaded, installed, and executed. The system 340 can include memory resource 348, and the processing resource 342 can be coupled to the memory resource 348.

Processing resource 342 can execute CRI 358 that can be stored on an internal or external memory resource 348. The processing resource 342 can execute CRI 358 to perform various functions, including the functions described with respect to FIGS. 1, 2A, and 2B.

The CRI 358 can include modules 350, 352, 354, 356. The modules 350, 352, 354, 356, can include CRI 358 that when executed by the processing resource 342 can perform a number of functions, and in some instances can be sub-modules of other modules. In another example, the number of modules 350, 352, 354, 356 can comprise individual modules at separate and distinct locations (e.g., CRM etc.).

In some examples, the system can include a receipt module 350. A receipt module 350 can include CRI that when executed by the processing resource 342 can receive, at a discussion forum associated with a number of threads, a search query. For example, a consumer on a consumer product discussion forum may have a question regarding a problem with a product, the product's function, warranty, etc., and he or she may choose to post that question on the forum. Receiving this search query can trigger a response to search for a thread in the forum relevant to the search query.

A build module 352 can include CRI that when executed by the processing resource 342 can build, in response to the search query, a vector of thread title keywords and a vector of thread content keywords based on the number of threads. In some examples, a thread can include feature vectors for a thread title and a thread content. These feature vectors can be utilized in clustering keywords and forming data trees, for example.

A design module 354 can include CRI that when executed by the processing resources 342 can iteratively design a first clustering data tree and a second clustering date tree. In a number of examples, the instructions executable to iteratively design comprise instructions executable to grow a first clustering data tree utilizing the thread title keyword vector, grow a second clustering data tree utilizing the thread content keyword vector; prune the first clustering data tree with respect to the second clustering data tree, and prune the second clustering data tree with respect to the first clustering data tree.

In some instances, pruning can be terminated when a change in a cost function (e.g., equation (2)) is less than a threshold value (e.g., one percent from one iteration to the next). In some examples, the first tree can be grown as a first tree-structured Gauss mixture vector quantizer (TS-GMVQ) tree and the second tree as a second TS-GMVQ tree. The first clustering tree can be grown utilizing a first set of subtree functionals and the second clustering tree can be grown utilizing a second set of subtree functionals (e.g., equations 11-14)).

A determination module 356 can include CRI that when executed by the processing resource 342 can determine a thread from within the number of threads that is relevant to the search query based on the iteratively designed first and second data trees. A relevant thread can include a thread that has a particular relationship to the search query. For example, if a question (e.g., the search query) posed is related to a rebooting problem in a particular computer, a relevant thread may include information on rebooting issues in the particular computer. Even if the question is not identical, the thread containing the information may be relevant, for example.

In a number of examples, the processing resource 342 coupled to the memory resource 348 can execute CRI 358 to receive at a consumer product support forum, a search query from a consumer and extract a number of keywords from a number of threads inside the consumer product support forum. The processing resource 342 coupled to the memory resource 348 can execute CRI 358 to cluster, utilizing multi-view, hierarchical clustering, the number of extracted keywords into thread title clusters and thread content clusters, such that each is clustered with respect to the other, search for and retrieve threads relevant to the search query based on the clustering, and present the retrieved threads in a rank-ordered fashion to the consumer.

The processing resource 342 coupled to the memory resource 348 can execute CRI 358 to extract the number of keywords comprise instructions executable to extract the number of keywords utilizing term frequency-inverse document frequency, term co-occurrence, and a removal of stop-words. In some examples, processing resource 342 coupled to the memory resource 348 can execute CRI 358 to design the thread title cluster and the thread content cluster such that a probability of disagreement between the clusters is minimized, and wherein the thread title cluster and the thread content cluster are designed with respect to one another, (e.g., equation (1)).

In number of embodiments, the thread title clusters and the thread content clusters comprise a limited number of clusters (e.g., 100, 500, etc.), such that search, retrieval, and ranking can be increased in speed and efficiency. Too many clusters (e.g., 1,000,000,000 clusters) can result in lags in search, retrieval, and ranking, for example.

As used herein, “logic” is an alternative or additional processing resource to perform a particular action and/or function, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed is:

1. A method for searching threads, comprising:
extracting a number of keywords from a number of threads inside a discussion forum in response to a search query;
clustering the number of keywords utilizing thread titles and thread content from the within the number of threads; and
searching for a thread from within the number of threads that is relevant to the search query based on the clustering.

2. The method of claim 1, comprising retrieving the relevant thread.

3. The method of claim 1, wherein clustering the number of keywords comprises a hierarchical, multi-view clustering of the number of threads inside the discussion forum.

4. The method of claim 1, wherein extracting the number of keywords comprises:
forming a vector of keywords in a repository of forum threads; and
generating a binary features vector for each thread.

5. The method of claim 4, wherein generating a binary features vector for each thread comprises generating a thread title feature vector and a thread content feature vector for each thread.

6. The method of claim 1, wherein clustering the number of keywords comprises:
growing a thread title data tree and a thread content data tree;
utilizing a Breiman, Freidman, Olshen, and Stone (BFOS) model, pruning the thread title data tree with respect to the thread content data tree;
utilizing the BFOS model, pruning the thread content data tree with respect to the thread title data tree;
in response to a change in a cost function being below a threshold value, terminating pruning of the thread title data tree and the thread content data tree; and
in response to a change in the cost function being above the threshold value, growing a new thread title data tree and a new thread content data tree.

7. The method of claim 1, wherein clustering the number of keywords comprises clustering the number of keywords in an unsupervised setting.

8. A non-transitory computer-readable medium storing a set of instructions executable by a processing resource to:
receive at a consumer product support forum, a search query from a consumer;
extract a number of keywords from a number of threads inside the consumer product support forum;
cluster, utilizing multi-view, hierarchical clustering, the number of extracted keywords into thread title clusters and thread content clusters, such that each keyword is clustered with respect to the other;
search for and retrieve threads relevant to the search query based on the clustering; and
present the retrieved threads in a rank-ordered fashion to the consumer.

9. The non-transitory computer-readable medium of claim 8, wherein the instructions executable to extract the number of keywords comprise instructions executable to extract the number of keywords utilizing term frequency-inverse document frequency, term co-occurrence, and a removal of stop-words.

10. The non-transitory computer-readable medium of claim 8, wherein the thread title clusters and the thread content clusters comprise a limited number of clusters.

11. The non-transitory computer-readable medium of claim 8, wherein the instructions executable to cluster the number of extracted keywords comprise instructions executable to design the thread title cluster and the thread content cluster such that a probability of disagreement between the clusters is minimized, and wherein the thread title cluster and the thread content cluster are designed with respect to one another.

12. A system, comprising:
a processing resource; and
a memory resource communicatively coupled to the processing resource containing instructions executable by the processing resource to:
receive, at a discussion forum associated with a number of threads, a search query;
in response to the search query, build a vector of thread title keywords and a vector of thread content keywords based on the number of threads;
iteratively design a first clustering data tree and a second clustering date tree, wherein the instructions executable to iteratively design comprise instructions executable to:
grow a first clustering data tree utilizing the thread title keyword vector;
grow a second clustering data tree utilizing the thread content keyword vector;
prune the first clustering data tree with respect to the second clustering data tree;
prune the second clustering data tree with respect to the first clustering data tree; and
determine a thread from within the number of threads that is relevant to the search query based on the iteratively designed first and second data trees.

13. The system of claim 12, wherein the instructions executable to prune the first clustering data tree and the second clustering data tree comprise instructions executable to terminate pruning when a change in a cost function is less than a threshold value.

14. The system of claim 12, wherein the instructions executable to grow the first clustering tree and the second clustering tree comprise instructions to grow the first tree as a first tree-structured Gauss mixture vector quantizer (TS-GMVQ) tree and the second tree as a second TS-GMVQ tree.

15. The system of claim 12, wherein the instructions executable to grow the first clustering data tree and the second clustering data tree comprise instructions executable to:
grow the first clustering tree utilizing a first set of subtree functionals; and
grow the second clustering tree utilizing a second set of subtree functionals.
